(19) United States
(12) Patent Application Publication
(10) Pub. No.: US 2012/0013995 A1
(43) Pub. Date: Jan. 19, 2012

(54) ZOOM LENS AND IMAGE PICKUP APPARATUS INCLUDING THE ZOOM LENS

(75) Inventor: Hiroshi Saruwatari, Utsunomiya-shi (JP)

(73) Assignee: CANON KABUSHIKI KAISHA, Tokyo (JP)

(21) Appl. No.: 13/142,666

(22) PCT Filed: Jan. 6, 2010
(86) PCT No.: PCT/JP2010/000053

§ 371 Date: Jun. 29, 2011

(30) Foreign Application Priority Data
Jan. 7, 2009 (JP) 2009-001447

(51) Int. Cl. G02B 15/14

(52) U.S. Cl. 359/687

(57) ABSTRACT

A zoom lens includes, in order from an object side to an image side, a first lens unit having a positive refractive power, a second lens unit having a negative refractive power, an aperture stop, a third lens unit having a positive refractive power, and a fourth lens unit having a positive refractive power. Each lens unit and the aperture stop move during zooming. In zooming from a wide angle end to a telephoto end, an amount of movement of the aperture stop Mp is set to a suitable amount.

### TECHNICAL FIELD

The present invention relates to a zoom lens and an image pickup apparatus including the zoom lens, and to, for example, a video camera, an electronic still camera, a TV camera (broadcasting camera), and a camera for silver halide photography.

### BACKGROUND ART

In an image taking optical system used in an image pickup apparatus, a zoom lens is required to have a short overall lens length, to be compact, to have high resolution, and to have a high zoom ratio. In addition, the zoom lens is required to have a short focal length at a wide angle end so that a wide image taking range can be obtained even if an image taking distance is short. Further, it is demanded that each lens unit be capable of being compactly accommodated by collapsing each lens unit when an image is not taken.

In general, in order to reduce the size of the entire zoom lens while increasing the zoom ratio, the refractive power of each lens unit making up the zoom lens may be increased and the number of lenses may be reduced. However, it becomes difficult to correct various aberrations.

If an attempt is made to accommodate each lens unit by collapsing it, an assembly error, such as falling of the lenses and the lens units, tends to increase, and, if the sensitivities of the lenses and the lens units are high, optical performance is reduced due to the assembly error. Therefore, it is desirable to minimize decentering sensitivities of the lenses and the lens units.

A zoom lens including, in order from an object side to an image side, a first lens unit having a positive refractive power, a second lens unit having a negative refractive power, a third lens unit having a positive refractive power, and a fourth lens unit having a positive refractive power is known.

Japanese Patent Laid-Open No. 2007-003554 discusses a zoom lens having a zoom ratio of approximately 18. This zoom lens is described as a zoom lens having a high zoom ratio and a wide angle of view. However, the amount by which a first lens unit is moved out is relatively large. Therefore, in order to reduce the overall lens length when the lens unit is collapsed, a lens barrel needs to be a multi-step lens barrel, as a result of which the structure of the lens barrel becomes complicated.

U.S. Pat. No. 7,167,320 discusses a zoom lens having a zoo ratio that is equal to or greater than 4.5. In this zoom lens, the amount of movement of a second lens unit at the time of zooming is small. Therefore, in order to further increase the zoom ratio, it is necessary to increase the amount of movement of a first lens unit. Consequently, in order to reduce the overall collapsing length, a lens barrel needs to be a multi-step lens barrel, thereby increasing the outside diameter of the lens barrel.

US Patent Application Publication No. 2009/0091841 discusses a zoom lens having a zoom ratio that is equal to or greater than 6.5. Even in this zoom lens, in order to further increase the zoom ratio, it is necessary to increase the amount of movement of a first lens unit, thereby making it difficult to reduce the size of the entire system while achieving a high zoom ratio.

US Patent Application Publication No. 2006/0146417 discusses a zoom lens that obtains a still image by vibrating the entire third lens unit perpendicularly to an optical axis and correcting image blur.

In the aforementioned zoom lens, in order to achieve high optical performance over the entire zoom range while reducing the size of the entire, lens system, when performing zooming, it is important to suitably set movement conditions of, in particular, the first lens unit and the aperture stop.

### CITATION LIST

### Patent Literature

PTL 1: Japanese Patent Laid-Open No. 2007-003554

PTL 2: U.S. Pat. No. 7,167,320

PTL 3: US Patent Application Publication No. 2009/0091841

PTL 4: US Patent Application Publication No. 2006/0146417

### SUMMARY OF INVENTION

A zoom lens according to the present invention includes, in order from an object side to an image side, a first lens unit having a positive refractive power, a second lens unit having a negative refractive power, an aperture stop, a third lens unit having a positive refractive power, and a fourth lens unit having a positive refractive power. Each lens unit and the aperture stop move during zooming. The zoom lens satisfies the following condition:

3.4<M1/Mp<50.0

where, in zooming from a wide angle end to a telephoto end, an amount of movement of the first lens unit is M1 and an amount of movement of the aperture stop is Mp.

According to the present invention, it is possible to provide a zoom lens having a wide angle of view and a high zoom ratio and having good optical performance over the entire zoom range.

### BRIEF DESCRIPTION OF DRAWINGS

FIG. 1 is a sectional view of lenses at a wide angle end according to a first embodiment of the present invention.

FIG. 2A shows aberrations according to the first embodiment of the present invention.

FIG. 2B shows aberrations according to the first embodiment of the present invention.

FIG. 3 is a sectional view of lenses at the wide angle end according to a second embodiment of the present invention.

FIG. 4A shows aberrations according to the second embodiment of the present invention.

FIG. 4B shows aberrations according to the second embodiment of the present invention.

FIG. 5 is a sectional view of lenses at the wide angle end according to a third embodiment of the present invention.

FIG. 6A shows aberrations according to the third embodiment of the present invention.

FIG. 6B shows aberrations according to the third embodiment of the present invention.

FIG. 7 is a sectional view of lenses at the wide angle end according to a fourth embodiment of the present invention.

FIG. 8A shows aberrations according to the fourth embodiment of the present invention.

FIG. 8B shows aberrations according to the fourth embodiment of the present invention.

FIG. 9 is a schematic view of an image pickup apparatus according to the present invention.

### DESCRIPTION OF EMBODIMENTS

Embodiments of a zoom lens and an image pickup apparatus including the zoom lens according to the present invention will hereunder be described.

A zoom lens according to the present invention includes, in order from an object side to an image side, a first lens unit having a positive refractive power, a second lens unit having a negative refractive power, an aperture stop, a third lens unit having a positive refractive power, and a fourth lens unit having a positive refractive power.

The zoom lens is such that each lens unit and the aperture stop move during zooming. A lens unit having refractive power, such as a converter lens, may be disposed at the object side of the first lens unit or the image side of the fourth lens unit.

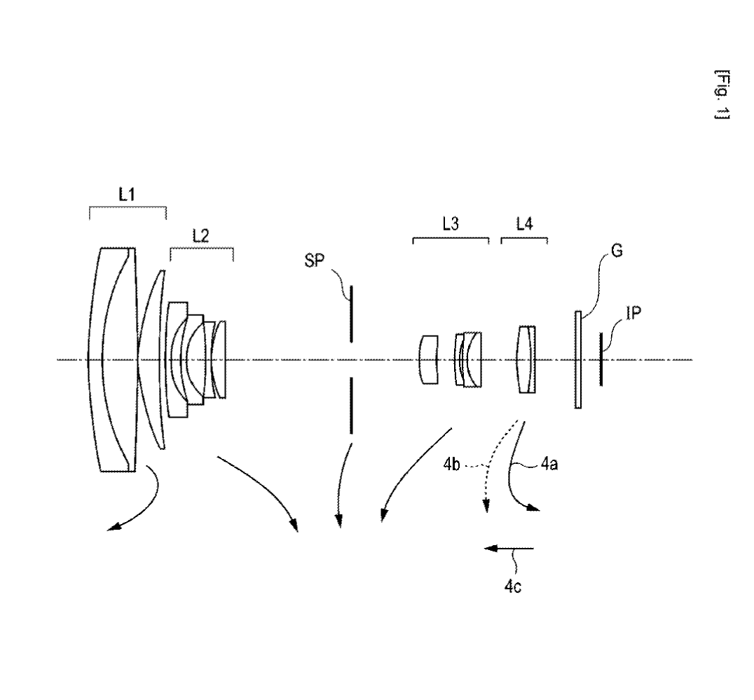

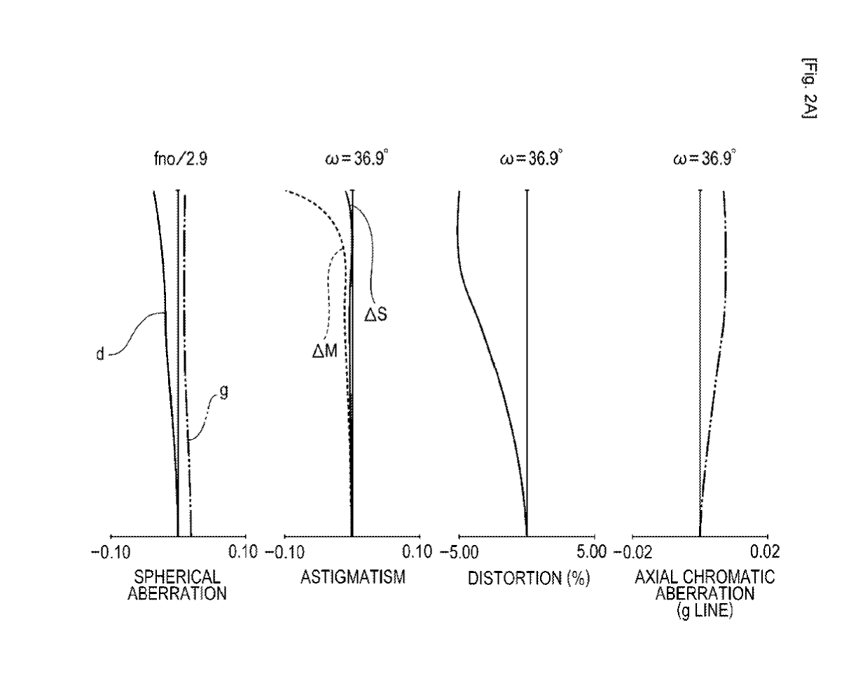

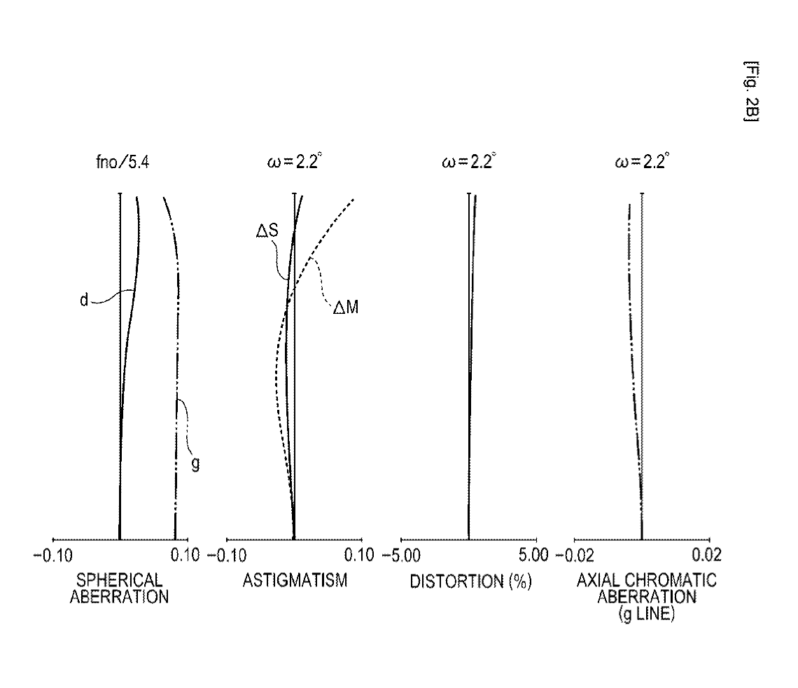

FIG. 1 is a sectional view of lenses at a wide angle end (short focal length end) of a zoom lens according to a first embodiment of the present invention. FIGS. 2A and 28 show aberrations at the wide angle end and a telephoto end (long focal length end) of the zoom lens according to the first embodiment, respectively.

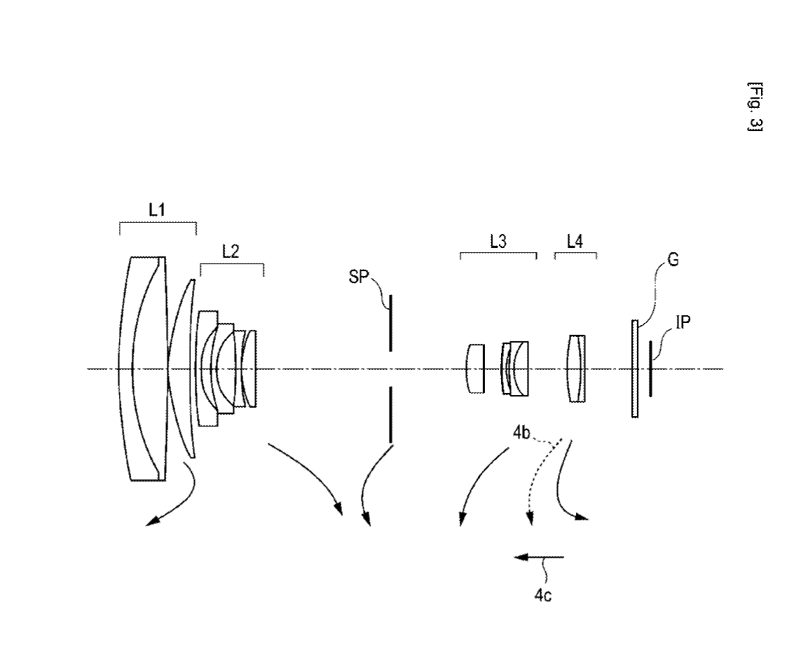

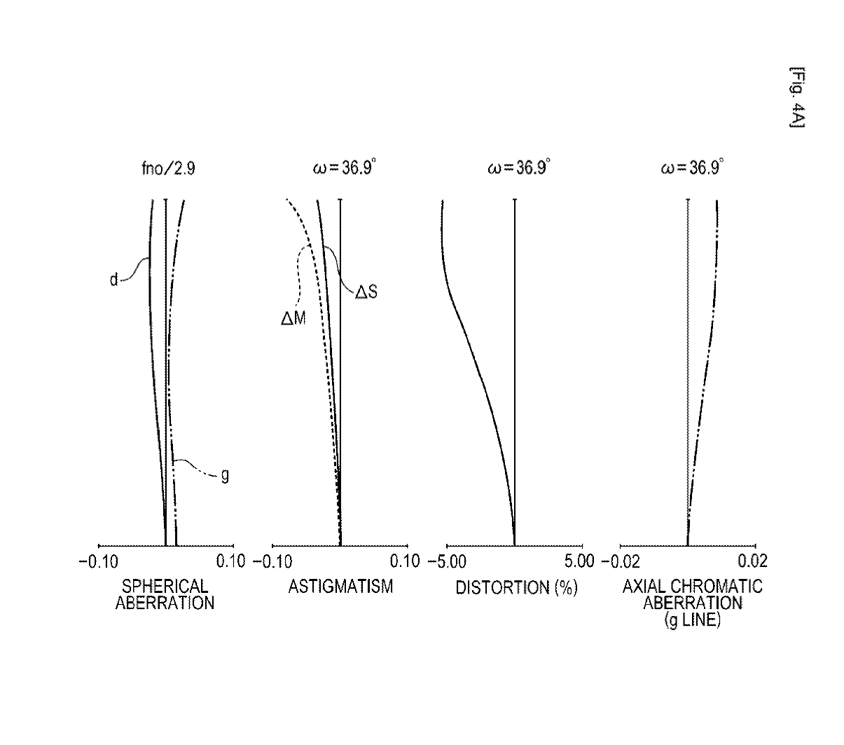

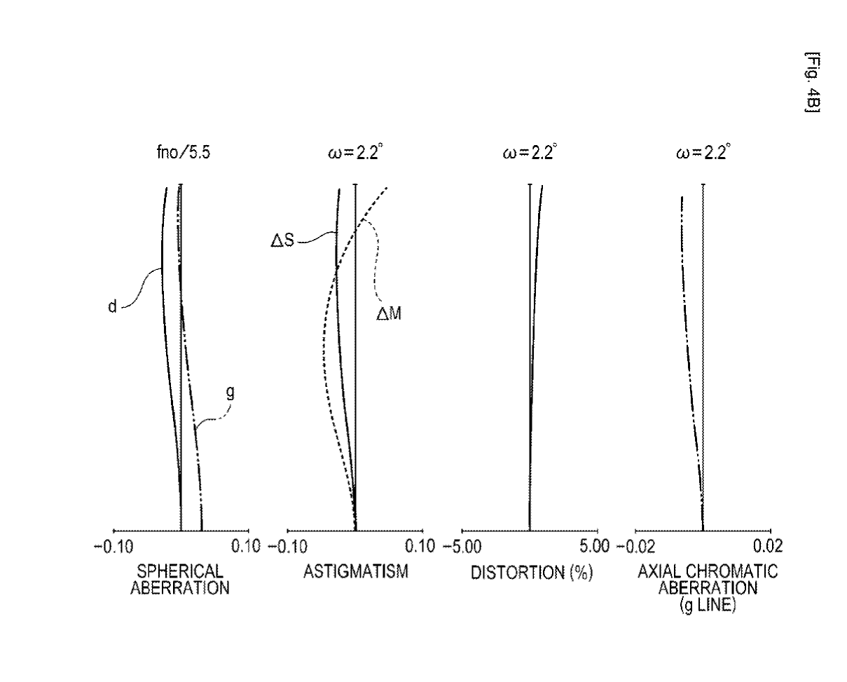

FIG. 3 is a sectional view of lenses at the wide angle end of a zoom lens according to a second embodiment of the present invention. FIGS. 4A and 48 show aberrations at the wide angle end and the telephoto end of the zoom lens according to the second embodiment, respectively.

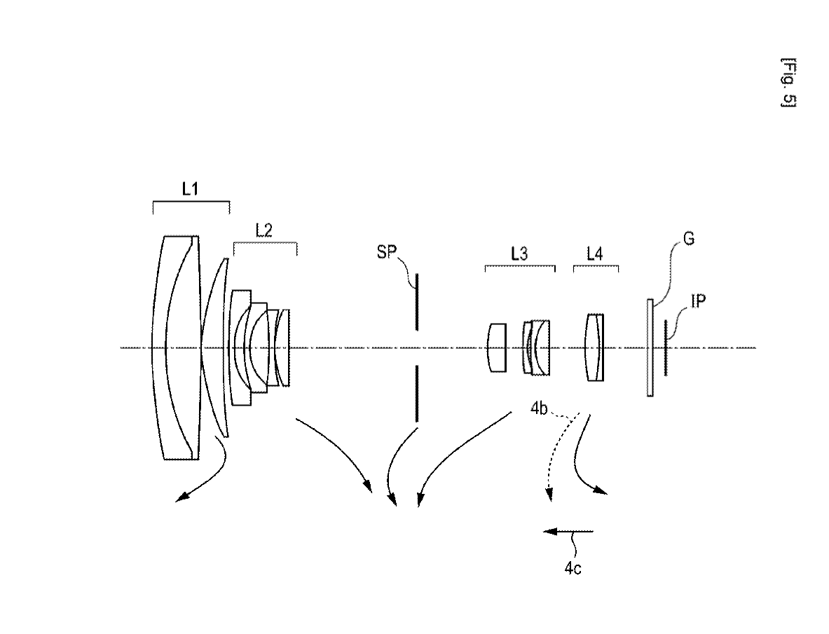

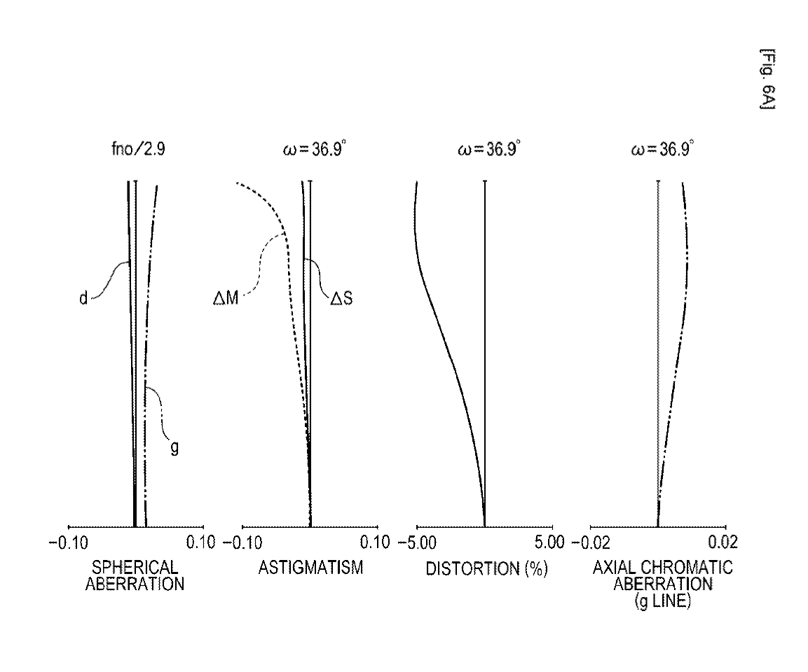

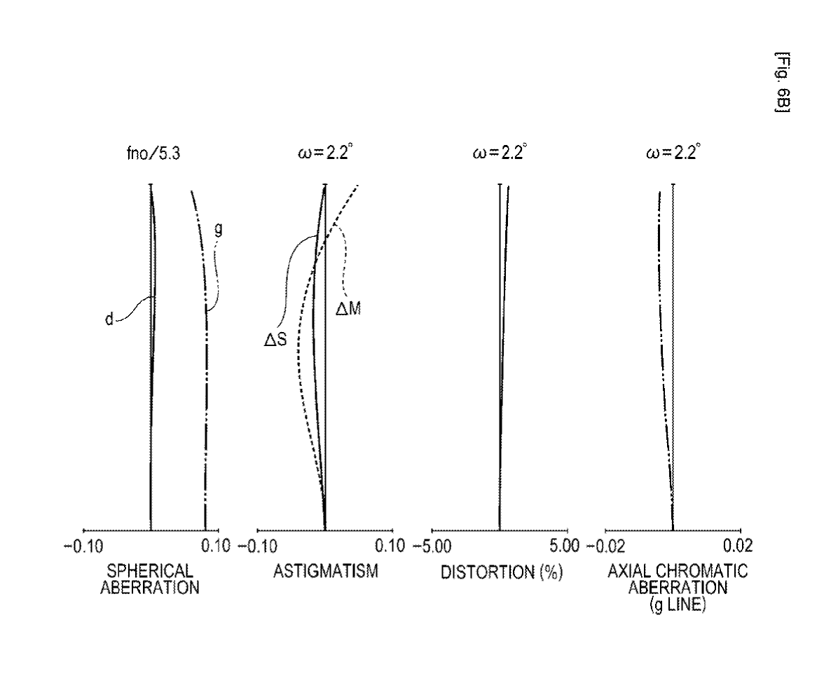

FIG. 5 is a sectional view of lenses at the wide angle end of a zoom lens according to a third embodiment of the present invention. FIGS. 6A and 68 show aberrations at the wide angle end and the telephoto end of the zoom lens according to the third embodiment, respectively.

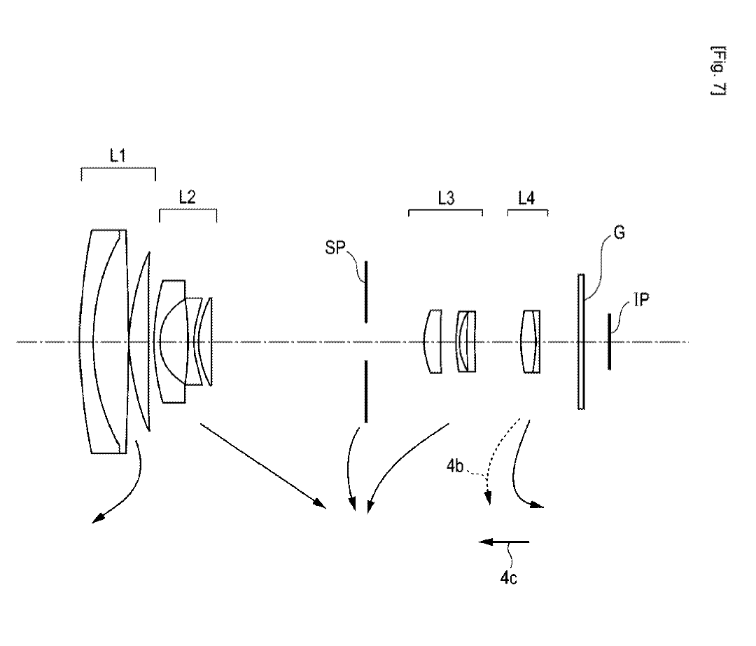

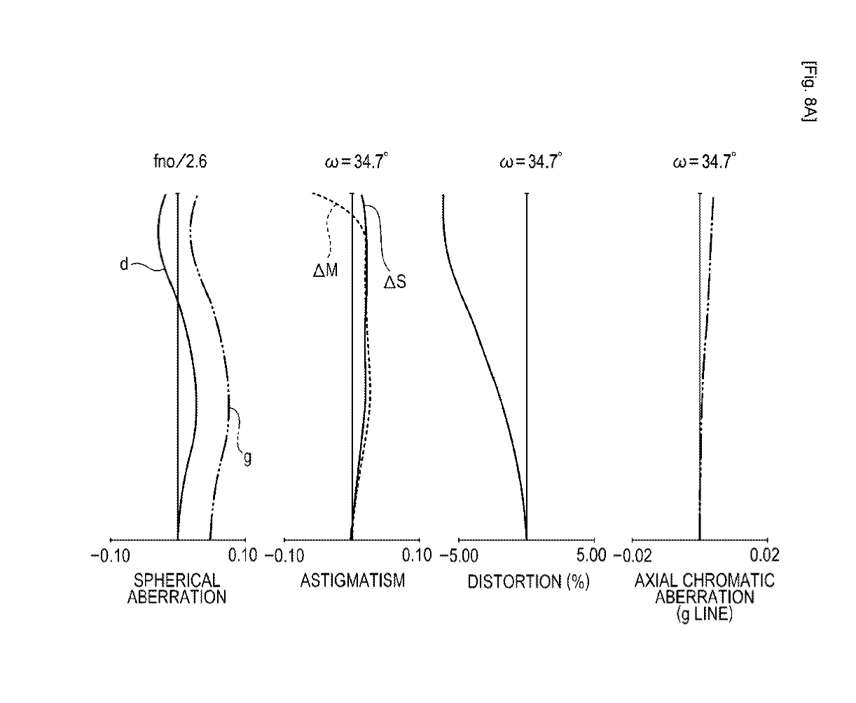

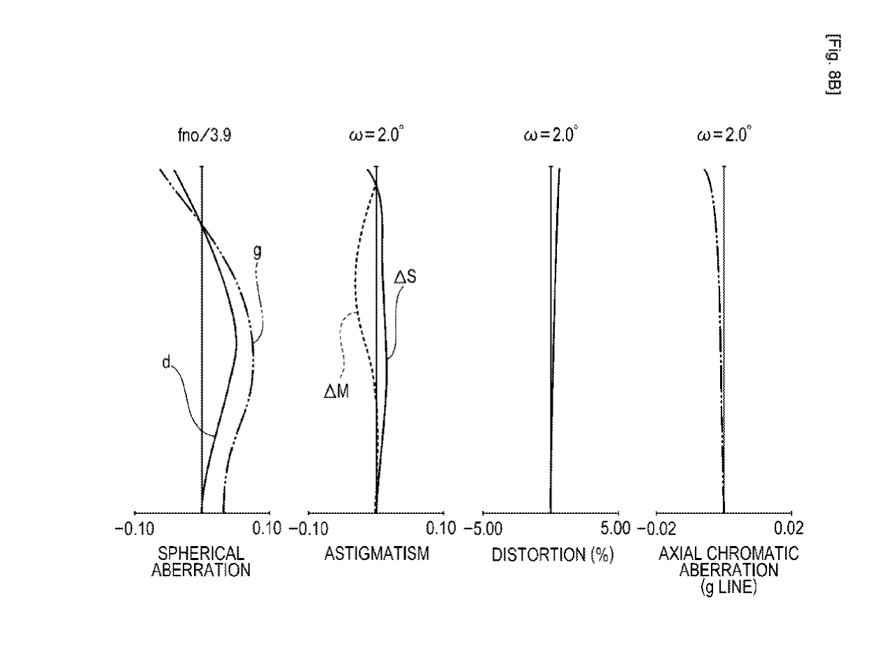

FIG. 7 is a sectional view of lenses at the wide angle end of a zoom lens according to a fourth embodiment of the present invention. FIGS. 8A and 8B show aberrations at the wide angle end and the telephoto end of the zoom lens according to the fourth embodiment, respectively.

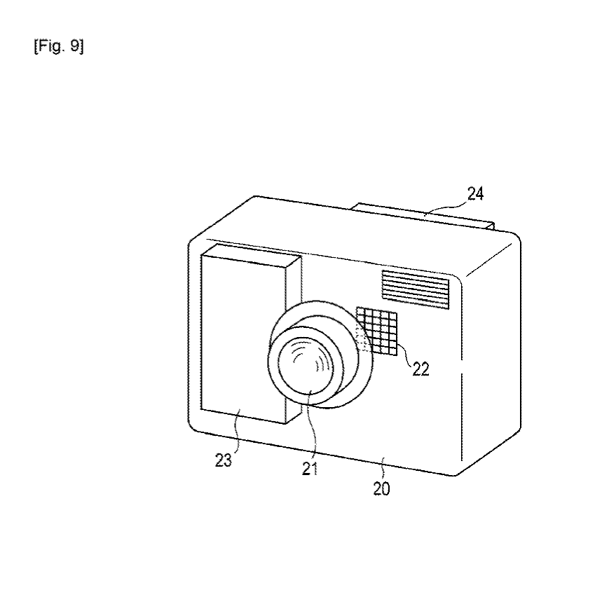

FIG. 9 is a schematic view of the main portion of a camera (image pickup apparatus) including the zoom lens according to the present invention. The zoom lens of each embodiment is an image taking optical system used in the image pickup apparatus such as a video camera, a digital camera, or a silver halide film camera.

In the sectional views of the lenses, the left side is the object side (front side), and the right side is the image side (rear side). i represents the order number of the lens unit from the object side, and Li represents an ith lens unit.

In each of the embodiments, L1 represents the first lens unit having a positive refractive power (optical power reciprocal of focal length), L2 represents the second lens unit having a negative refractive power, L3 represents the third lens unit having a positive refractive power, and L4 represents the fourth lens unit having a positive refractive power.

SP denotes the aperture stop disposed at the object side of the third lens unit L3.

G denotes an optical block corresponding to an optical filter, a faceplate, a crystal low-pass filter, an infrared cut filter, etc.

IP denotes an image plane. When the zoom lens is used as an image taking optical system of a video camera or a digital still camera, the image plane corresponds to an image pickup plane of a solid-state image pickup element (photoelectric conversion element), such as a CCD sensor or a CMOS sensor. When the zoom lens is used as an image taking optical system of a silver halide film camera, the image plane corresponds to a photosensitive plane corresponding to a film plane.

In the aberration figures, d and g represent the d line and the g line, respectively; [delta]M and [delta]S represent a meridional image plane and a sagittal image plane, respectively; and axial chromatic aberration is represented by the g line. [omega] represents a half angle of view, fno represents an F number.

In each of the embodiments below, the wide angle end and the telephoto end refer to zooming positions provided when a variable power lens unit (second lens unit L2) is positioned at respective ends of its mechanically movable range along the optical axis.

In each of the embodiments, when performing a magnification variation operation from the wide angle end to the telephoto end, each lens unit and the aperture stop SP are moved as indicated by the arrows.

More specifically, in each embodiment, when performing the zooming operation (magnification variation) from the wide angle end to the telephoto end, the first lens unit L1 is moved along a locus convex toward the image side as shown by the arrow. In addition, the second lens unit L2 is moved monotonically toward the image side, the third lens unit L3 is moved toward the object side, and the fourth lens unit L4 is moved along a locus convex toward the object side.

When zooming is performed from the wide angle end to an intermediate zooming position, by temporarily moving the first lens unit L1 toward the image side, an entrance-pupil distance near the wide angle end is reduced, a ray height of off-axis light is reduced, and the effective diameter of a front lens is reduced.

In performing zooming, the first lens unit L1 and the third lens unit L3 are moved so that they are positioned closer to the object at the telephoto end than at the wide angle end, so that a high zoom ratio can be obtained while the overall lens length is kept small at the wide angle end.

In particular, in each embodiment, in zooming from the wide angle end to the telephoto end, the third lens unit L3 is moved toward the object side, so that the zoom ratio is shared by the third lens unit L3 and the fourth lens unit L4. Further, by moving the first lens unit L1, having a positive refractive power toward the object side, the second lens unit L2 is provided with a large magnification variation effect, so that a high zoom ratio is obtained without making the refractive powers of the first lens unit L1 and the second lens unit L2 very large.

A rear-focusing type that performs focusing by moving the fourth lens unit. L4 along the optical axis is used. Focusing from an object at infinity to a near object at the telephoto end is carried out by moving out the fourth lens unit L4 forward as shown by an arrow 4c in the sectional view of the lenses. A solid curve 4a and a dotted curve 4b of the fourth lens unit L4 represent movement loci for correcting an image plane variation resulting from the zooming from the wide angle end to the telephoto end during focusing on the object at infinity and the near object.

In each embodiment, by moving the light fourth lens unit L4 for the focusing, quick focusing, such as an automatic focus detection operation, is facilitated.

In each embodiment, by moving part of or the entire third lens unit L3 so as to have a component in a direction perpendicular to the optical axis, image blur taken image blur) occurring when the entire optical system is vibrated is corrected.

By this, an image stabilizing operation is performed without providing an additional lens unit for image stabilization or optical member such as a variable vertex angle prism, so that the size of the entire optical system is prevented from becoming large.

The lens unit that is moved perpendicularly to the optical axis for correcting image blur is not limited to the third lens unit L3. Since, in each embodiment, the aperture stop SP is disposed near the third lens unit L3, the outside diameter of the third lens unit L3 is small, so that, from the viewpoint of driving weight, the third lens unit. L3 is desirably used rather than the other lens units.

In each embodiment, when zooming from the wide angle end to the telephoto end, the aperture stop SP is moved along a locus convex toward the object side. In particular, when zooming, the aperture stop SP is moved independently of the third lens unit L3.

By this, the pupil-entrance position at a wide-angle-of-view region is situated as close as possible to the object, so that the effective diameter of the front lens (the effective diameter of the first lens unit L1) is small. In order to reduce the size of the zoom lens having a high zoom ratio, an axial distance between the front lens and the aperture stop SP at the telephoto end needs to be small.

Therefore, the aperture stop SP is moved so as to be positioned closer to the object at the telephoto end than at the wide angle end. However, if, when zooming from the wide angle end to the telephoto end, the amount of movement of the aperture stop SP toward the object side is increased, a movable range of the second lens unit L2 is reduced. This is disadvantageous from the viewpoint of increasing the zoom ratio. Therefore, it is desirable that the aperture stop SP move along a locus convex toward the object side so as to move toward the object side by a large amount near the wide angle end, and, during subsequent zooming, move toward the image side.

In each embodiment, when zooming from the wide angle end to the telephoto end, the amount of movement of the first lens unit is M and the amount of movement of the aperture stop is Mp. In this case, the following condition is satisfied:

3.4<M1/Mp<50.0 (1)

Here, the term “amount of movement” refers to a position change (relative difference) in an optical axis direction of a lens unit at a specified zooming position with respect to a fixed reference position (such as an image formation plane) during zooming (magnification variation). This term does not refer to the amount of movement other than to the specified zooming position.

The signs of the amount of movement are such that a position change from the reference position to the image side is positive, and position change from the reference position to the object side is negative.

By satisfying the Conditional Expression (1), a zoom lens having a wide angle of view and a high zoom ratio is achieved.

In order to ensure good imaging performance when the zoom lens is caused to have a wide angle of view and a high zoom ratio, in general, it is effective to increase the number of lenses of each lens unit or to reduce the refractive power of each lens unit and dispose each lens unit.

However, if such a method is used, the overall lens length tends to become long, or the size of the external shape of the lens barrel that depends upon the size of the front lens system tends to increase. In order to obtain high optical performance, an aspherical surface may be used. However, since it is difficult to form an aspherical surface, many aspherical surfaces cannot be used.

The Conditional Expression (1) expresses the ratio between the amount of movement of the first lens unit L1 and the amount of movement of the aperture stop SP during zooming. In general, in a zoom lens having a wide angle of view, an effective ray diameter of the front lens (the lens of the first lens unit that is closest to the object) is determined by a light ray bundle that is incident upon a location at a maximum image height near the wide angle end.

Therefore, in order to reduce the size of the entire system, it is desirable that the axial distance between the front lens and the aperture stop SP near the wide angle end be as small as possible so as not to adversely influence the imaging performance.

In a zoom lens of a type in which a first lens unit L1 is moved toward the object side when zooming from the wide angle end to the telephoto end, if the distance between a front lens and an aperture stop SP is increased, a light ray bundle that is incident upon a location at a maximum image height near the telephoto end may determine the effective diameter of the front lens. In this case, from the viewpoint of reducing the size of the entire system, it is desirable that the axial distance between the front lens and the aperture stop SP near the telephoto end be small as in the aforementioned case.

The Conditional Expression (1) is defined from such viewpoints.

In the case where M1/Mp falls below the lower limit of the Conditional Expression (1), and the amount of movement of the first lens unit L1 becomes too small, if the zoom ratio is increased, the effective diameter of the front lens tends to be increased. This is because, in the zoom lens of the type in each embodiment, since the share of zoom ratio of the second lens unit L2 is inevitably increased, it becomes necessary to increase a stroke (amount of movement) of the second lens unit L2 during zooming.

As a result, the distance between the front lens and the aperture stop SP becomes large, thereby making it difficult to make compact the entire system.

In the case where M1/Mp exceeds the upper limit of the Conditional Expression (1), and the amount of movement of the first lens unit L1 becomes too large, in order to reduce the overall lens length when the lens unit is collapsed, the lens barrel needs to be a multi-step lens barrel, and the lens barrel is increased in size in a radial direction. These are not desirable.

In addition, by forming the lens barrel so as to be a multi-step lens barrel, decentering of each lens unit tends to occur, thereby adversely influencing the imaging performance and, in particular, making it difficult to increase the zoom ratio.

Further, the Conditional Expression (1) indicates that the direction of movement of the first lens unit L1, and the direction of movement of the aperture stop SP during zooming are the same. If the directions of movements during the zooming are opposite to each other, the front lens and the aperture stop SP are separated from each other more than is necessary at either the wide angle end or the telephoto end. Therefore, it becomes difficult to make the lens barrel compact.

It is desirable that the numerical range of the Conditional Expression (1) set as follows:

3.5<M1/Mp<45.0 (1a)

According to this range, it becomes easy to obtain high imaging performance over the entire zooming range while achieving a wider angle of view and a higher zoom ratio.

Accordingly, according to each embodiment, it is possible to obtain a zoom lens having a higher zoom ratio and having good optical performance over the entire zooming range from the wide angle end to the telephoto end.

In each embodiment, it is further desirable that at least one of the following various conditions be satisfied.

The focal length at the wide angle end of the zoom lens is fw, and the focal length at the telephoto end of the zoom lens is ft. The focal length fm of the entire system at the intermediate zooming position is fm=[square root]((w*ft). The amount of movement of the aperture stop SP from the wide angle end to the intermediate zooming position is Mpm.

The amount of movement of the second lens unit L2 during zooming from the wide angle end to the telephoto end is M2.

In zooming from the wide angle end to the telephoto end, the amount of change in the axial distance between the aperture stop SP and the third lens unit L3 is [delta]dp.

The term “amount of change in the distance [delta]dp” is such that the distance between the aperture stop SP and the third lens unit L3, disposed at the image side thereof, at the wide angle end is dpw, and the distance between the aperture stop SP and the third lens unit L3, disposed at the image side thereof, at the telephoto end is dpt.

Here, [delta]dp dpw dpt.

Here, at least one of the following conditions may be satisfied:

0.7<Mpm/Mp<7.0 (2)

−0.8<Mp/M2<0.0 (3)

1.3<[delta]dp/fw<4.0 (4)

According to these conditions, advantages that are in accordance therewith can be obtained.

The Conditional Expression (2) defines the ratio between the amount of movement during zooming of the aperture stop SP from the wide angle end to the middle zooming position (intermediate zooming position) and the amount of movement during zooming from the wide angle end to the telephoto end.

Due to a wider angle of view, the effective diameter of the front lens is determined on the basis of a light ray bundle that is incident upon a location at the maximum image height near the wide angle end. The smaller the distance between the aperture stop SP and the front lens near the wide angle end, the better for reducing the diameter of the entire system.

If Mpm/Mp falls below the lower limit of the Conditional Expression (2), the amount of movement of the aperture stop SP toward the object side from the wide angle end to the middle zooming position is too small. Therefore, the axial distance between the front lens and the aperture stop SP becomes too large, thereby making it difficult to reduce the diameter of the entire system.

If Mpm/Mp exceeds the upper limit of the Conditional Expression (2), at an intermediate image height in the middle zooming area, a light beam existing above a principal ray impinges excessively upon the system. Therefore, color flare occurs often, and imaging performance is reduced. These are not desirable.

The Conditional Expression (3) defines the amount of movement of the aperture stop SP and the amount of movement of the second lens unit L2 when zooming from the wide angle end to the telephoto end.

In the lens structure of the zoom lens according to each embodiment, the distance between the second lens unit L2 and the third lens unit L3 at the wide angle end becomes a maximum movable range of the second lens unit L2 and the aperture stop SP during the zooming. As can be understood from the signs, the second lens unit L2 and the aperture stop SP move in opposite directions during the zooming.

If Mp/M2 falls below the lower limit of the Conditional Expression (3), the amount of movement of the aperture stop SP is too small. Therefore, the amount of movement of the third lens unit L3 disposed closer to the image than the aperture stop SP inevitably becomes small. This means that the burden of correcting aberrations during zooming is concentrated on the second lens Unit L2. This makes it difficult to restrict variations in aberrations caused by a higher zoom ratio.

In contrast, if Mp/M2 exceeds the upper limit of the Conditional Expression (3), the amount of movement of the second lens unit L2 is too small, thereby making it difficult to increase the zoom ratio of the zoom lens. In order to achieve a higher zoom ratio by a small amount of movement, it is necessary to increase the refractive power of the second lens unit L2 and to increase the number of lenses for maintaining high optical performance.

As a result, the second lens unit L2 becomes heavy, or the entire second lens unit L2 becomes large. These are not desirable.

The Conditional Expression (4) standardizes the amount of variation during zooming in the distance between the aperture stop SP and the third lens unit L3, disposed adjacent to the image side thereof, using the focal length at the wide angle end.

In the lens structure of the zoom lens according to each embodiment, the distance between the aperture stop SP and the third lens unit L3, disposed adjacent to the image side thereof, considerably influences, in particular, the size of the external shape of the lens barrel and the imaging performance at the wide angle end.

If [delta]dp/fw falls below the lower limit of the Conditional Expression (4), and the aperture stop SP is not disposed sufficiently close to the object, that is, the distance between the front lens and the aperture stop SP is too large, it becomes difficult to reduce the effective diameter of the front lens. In contrast, if [delta]dp/fw exceeds the upper limit of the Conditional Expression (4), and the distance between the aperture stop SP and the third lens unit L3, disposed adjacent to the image side thereof, becomes too large, the effective diameter of the third lens unit L3 becomes too large, thereby making it difficult to correct spherical aberration at the wide angle end.

In each embodiment, in order to achieve a higher zoom ratio while reducing variations in aberrations during zooming and corrections of the aberrations, it is desirable to set the numerical ranges of the Conditional Expressions (2) to (4) as follows:

0.8<Mpm/Mpt<6.0 (2a)

−0.6<Mp/M2<0.0 (3a)

1.35<[delta]dp/fw<3.00 (4a)

Accordingly, according to each embodiment, by suitably setting, for example, the refractive power of each lens unit and the amount of movement of each lens unit in performing zooming, it is possible to reduce the overall lens length even if the angle of view is wide and the zoom ratio is high.

In particular, it is possible to obtain a zoom lens having good optical performance over the entire zooming range from the wide angle end to the telephoto end.

Next, the structure of each lens unit will be described.

Since the effective lens diameter of the first lens unit L1 becomes large, in order to make the entire first lens unit L1 smaller and lighter, it is desirable to reduce the number of lenses.

In each embodiment, the first lens unit L1 includes three lenses, that is, in order from the object side to the image side, a cemented lens, in which one negative lens (a lens having a negative refractive power) and one positive lens (a lens having a positive refractive power) are cemented to each other, and a positive lens. By this, chromatic aberration and spherical aberration occurring due to a higher magnification (a higher zoom ratio) are reduced.

In each embodiment, the second lens unit L2 includes at least two negative lenses at locations closest to the object.

More specifically, in each of the first to third embodiments, the second lens unit L2 includes four independent lenses, that is, in order from the object side to the image side, two negative lenses whose object-side surfaces have convex meniscus forms, a negative lens whose both surfaces have concave forms, and a positive lens whose object-side surface has a convex form.

By this, variations in aberrations during zooming are reduced, and, in particular, distortion at the wide angle end and spherical aberration at the telephoto end are properly corrected.

In the fourth embodiment, the second lens unit L2 includes, in order from the object side to the image side, two negative lenses and one positive lens. This reduces the overall lens length and makes the second lens unit L2 compact.

In the fourth embodiment, in order to easily achieve these, the negative lens that is provided closest to the object has an aspherical surface, so that optical performance is increased while reducing the size of the entire system.

In each embodiment, the third lens unit L3 includes as a whole three or more lenses including two positive lenses and a negative lens whose image-side surface has a concave form. By this, by reducing the principal-point distance between the second lens unit L2 and the third lens unit L3, the lens lengths of the third lens unit L3 and those that follow are reduced.

The third lens unit L3 has one or more aspherical surfaces. By this, variations in aberrations caused by zooming are properly corrected.

In the first to third embodiments, by using a cemented lens in the third lens unit L3, variations in chromatic aberrations during zooming are restricted and aberrations caused by decentering when correcting image blur by decentering the third lens unit L3 from the optical axis is restricted.

In each embodiment, by forming the fourth lens unit L4 including a cemented lens, in which a negative lens and a positive lens whose object-side surface has a convex form are cemented to each other, variations in chromatic aberration during focusing is restricted while reducing weight.

The zoom lens according to each embodiment having the above-described structure is one in which the entire system is compact while, at the wide angle end, an angle of view (image-taking angle of view) is large and a high zoom ratio is achieved.

Next, Numerical Examples 1 to 4 corresponding to the first to fourth embodiments, respectively, according to the present invention will be shown. In each numerical example, i denotes the order number of an optical surface from the object side, ri denotes a curvature radius of an ith optical surface (ith surface), di denotes a distance between the ith surface and the (i+1)th surface, and ni and [nu]i denote a refractive index and an Abbe number of a material of an ith optical member with reference to the d-line, respectively.

If k represents eccentricity; B, C, D, E, A′, B′, and C″ represent aspherical surface coefficients, and a displacement in an optical axis direction at the position of a height h from an optical axis is x with reference to a vertex of a surface, the form of an aspherical surface is determined by:

x=(h²/R)/[1+[1−(1+k)(h/R)²]^{1/2}]+Bh⁴+Ch⁶+Dh⁸+Eh¹⁰+A′h³+B′h⁵+C′h⁷

Here, R represents a radius of curvature. For example, “E^{-z}” means “10^{-z}.” f represents a focal length. Rio represents an F number, and [omega] represents a half angle of view.

In the numerical examples, the last two surfaces correspond to surfaces of an optical block such as a filter or a faceplate.

Table 17 shows correspondences with the aforementioned conditional expressions in each of the numerical examples.

### Numerical Example 1

TABLE 1

| i | ri | di | ni | [nu]i |
|---|---|---|---|---|
| 1 | 91.458 | 2.00 | 1.80610 | 33.3 |
| 2 | 34.222 | 6.20 | 1.49700 | 81.5 |
| 3 | −261.230 | 0.20 | 1. | |
| 4 | 33.178 | 3.60 | 1.69680 | 55.5 |
| 5 | 138.908 | VARIABLE | 1. | |
| 6 | 60.396 | 1.00 | 1.88300 | 40.8 |
| 7 | 11.399 | 1.90 | 1. | |
| 8 | 26.065 | 0.85 | 1.83481 | 42.7 |
| 9 | 9.008 | 3.30 | 1. | |
| 10 | −67.711 | 0.80 | 1.83400 | 37.2 |
| 11 | 30.418 | 0.20 | 1. | |
| 12 | 15.874 | 2.25 | 1.92286 | 18.9 |
| 13 | 163.511 | VARIABLE | 1. | |
| 14 | (STOP) | VARIABLE | 1. | |
| 15* | 11.553 | 3.00 | 1.69350 | 53.2 |
| 16 | 110.250 | 3.00 | 1. | |
| 17 | 38.290 | 0.90 | 1.65844 | 50.9 |
| 18 | 12.267 | 0.50 | 1. | |
| 19 | 22.688 | 0.70 | 2.00069 | 25.5 |
| 20 | 8.329 | 2.50 | 1.72000 | 50.2 |
| 21 | −45.246 | VARIABLE | 1. | |
| 22 | 24.839 | 2.50 | 1.77250 | 49.6 |
| 23 | −20.522 | 0.60 | 1.69895 | 30.1 |
| 24 | 520.416 | VARIABLE | 1. | |
| 25 | INFINITY | 0.950 | 1.51633 | 64.1 |
| 26 | INFINITY | | | |

TABLE 2
ASPHERICAL SURFACE

| | | | | |
|---|---|---|---|---|
| (15TH SURFACE) | k = 6.49556E−1 | | | |
| | B = −1.04689E−4 | C = 1.11852E−6 | D = 1.71101E−8 | E = −5.84379E−9 |

TABLE 3
VARIOUS DATA

| ZOOM RATIO | 19.21 | | |
|---|---|---|---|
| | WIDE ANGLE | INTERMEDIATE | TELEPHOTO |
| FOCAL LENGTH | 5.15 | 22.61 | 98.95 |
| F NUMBER | 2.87 | 3.79 | 5.43 |
| ANGLE OF VIEW | 36.9 | 9.7 | 2.2 |
| IMAGE HEIGHT | 3.87 | 3.87 | 3.87 |
| OVERALL LENS | 87.20 | 93.13 | 109.70 |
| LENGTH | | | |
| BF | 10.96 | 19.83 | 7.97 |
| d5 | 0.90 | 20.33 | 38.12 |
| d13 | 21.78 | 2.12 | 1.85 |
| d14 | 11.57 | 5.84 | 1.40 |
| d21 | 6.00 | 9.02 | 24.39 |
| d24 | 7.00 | 15.87 | 4.01 |

TABLE 4
ZOOM LENS UNIT DATA

| UNIT | STARTING SURFACE | FOCAL LENGTH |
|---|---|---|
| 1 | 1 | 56.04 |
| 2 | 6 | −9.27 |
| 3 | 13 | 21.23 |
| 4 | 19 | 30.02 |

TABLE 5

| i | ri | di | ni | [nu] i |
|---|---|---|---|---|
| 1 | 81.580 | 2.00 | 1.80610 | 33.3 |
| 2 | 32.093 | 5.80 | 1.49700 | 81.5 |
| 3 | −431.793 | 0.20 | 1. | |
| 4 | 32.665 | 4.00 | 1.69680 | 55.5 |
| 5 | 162.575 | VARIABLE | 1. | |
| 6 | 73.762 | 1.00 | 1.88300 | 40.8 |
| 7 | 11.522 | 1.90 | 1. | |
| 8 | 29.357 | 0.85 | 1.83400 | 37.2 |
| 9 | 9.739 | 3.30 | 1. | |
| 10 | −28.518 | 0.80 | 1.83400 | 37.2 |
| 11 | 59.869 | 0.20 | 1. | |
| 12 | 20.822 | 2.25 | 1.92286 | 18.9 |
| 13 | −80.418 | VARIABLE | 1. | |
| 14 | (STOP) | VARIABLE | 1. | |
| 15* | 11.784 | 3.00 | 1.69350 | 53.2 |
| 16 | 2857.738 | 3.00 | 1. | |
| 17 | 58.363 | 0.90 | 1.64769 | 33.8 |
| 18 | 13.498 | 0.50 | 1. | |
| 19 | 32.495 | 0.70 | 2.00330 | 28.3 |
| 20 | 8.084 | 2.40 | 1.74400 | 44.8 |
| 21 | −48.830 | VARIABLE | 1. | |
| 22 | 19.455 | 2.70 | 1.77250 | 49.6 |
| 23 | −14.540 | 0.60 | 1.80610 | 33.3 |
| 24 | −191.527 | VARIABLE | 1. | |
| 25 | INFINITY | 0.80 | 1.51633 | 64.1 |
| 26 | INFINITY | | | |

### Numerical Example 2

TABLE 6
ASPHERICAL SURFACE

| (15TH SURFACE) | k = 1.38974 | | | |
|---|---|---|---|---|
| | B = −1.58071E−4 | C = −2.00290E−6 | D = 3.83159E−9 | E = −5.84379E−10 |

TABLE 7
VARIOUS DATA

| ZOOM RATIO | 19.41 | | |
|---|---|---|---|
| | WIDE ANGLE | INTERMEDIATE | TELEPHOTO |
| FOCAL LENGTH | 5.15 | 22.71 | 100.00 |
| F NUMBER | 2.87 | 3.80 | 5.54 |
| ANGLE OF VIEW | 36.9 | 9.81 | 2.21 |
| IMAGE HEIGHT | 3.87 | 3.87 | 3.87 |
| OVERALL LENS | 89.23 | 97.54 | 108.97 |
| LENGTH | | | |
| BF | 10.75 | 16.66 | 6.74 |
| d5 | 0.90 | 21.48 | 36.18 |
| d13 | 22.75 | 4.69 | 1.75 |
| d14 | 12.22 | 5.17 | 2.00 |
| d21 | 6.50 | 13.44 | 26.21 |
| d24 | 8.00 | 13.91 | 4.01 |

TABLE 8
ZOOM LENS UNIT DATA

| UNIT | STARTING SURFACE | FOCAL LENGTH |
|---|---|---|
| 1 | 1 | 53.91 |
| 2 | 6 | −9.75 |
| 3 | 15 | 23.37 |
| 4 | 22 | 24.13 |

### Numerical Example 3

TABLE 9

| i | ri | dl | ni | [nu] i |
|---|---|---|---|---|
| 1 | 95.268 | 2.00 | 1.80610 | 33.3 |
| 2 | 35.014 | 6.00 | 1.49700 | 81.5 |
| 3 | 270.255 | 0.20 | 1. | |
| 4 | 34.847 | 3.90 | 1.69680 | 55.5 |
| 5 | 168.865 | VARIABLE | 1. | |
| 6 | 63.684 | 1.00 | 1.88300 | 40.8 |
| 7 | 11.838 | 1.90 | 1. | |
| 8 | 29.553 | 0.90 | 1.83481 | 42.7 |
| 9 | 9.195 | 3.30 | 1. | |
| 10 | −43.519 | 0.80 | 1.83481 | 42.7 |
| 11 | 56.929 | 0.20 | 1. | |
| 12 | 17.161 | 2.00 | 1.92286 | 18.9 |
| 13 | 140.797 | VARIABLE | 1. | |
| 14 | (STOP) | VARIABLE | 1. | |
| 15* | 11.413 | 3.00 | 1.69350 | 53.2 |
| 16 | 393.819 | 3.00 | 1. | |
| 17 | 47.600 | 0.90 | 1.65844 | 50.9 |
| 18 | 12.574 | 0.44 | 1. | |
| 19 | 27.959 | 0.70 | 2.00069 | 25.5 |
| 20 | 7.766 | 2.70 | 1.74400 | 44.8 |
| 21 | −39.039 | VARIABLE | 1. | |
| 22 | 23.269 | 2.50 | 1.80400 | 46.6 |
| 23 | −16.607 | 0.60 | 1.69895 | 30.1 |
| 24 | 116.813 | VARIABLE | 1. | |
| 25 | INFINITY | 0.80 | 1.51633 | 64.1 |
| 26 | INFINITY | | | |

TABLE 10
ASPHERICAL SURFACE

| (15TH SURFACE) | k = −8.79203E-1 | | | |
|---|---|---|---|---|
| | B = −1.37623E−4 | C = −1.29310E−6 | D = 8.16656E−9 | E = −5.84379E−10 |

TABLE 11
VARIOUS DATA

| ZOOM RATIO | 19.21 | | |
|---|---|---|---|
| | WIDE ANGLE | INTERMEDIATE | TELEPHOTO |
| FOCAL LENGTH | 5.15 | 22.60 | 98.94 |
| F NUMBER | 2.87 | 4.02 | 5.29 |
| ANGLE OF VIEW | 36.89 | 9.70 | 2.24 |
| IMAGE HEIGHT | 3.87 | 3.87 | 3.87 |
| OVERALL LENS | 86.75 | 96.46 | 109.77 |
| LENGTH | | | |
| BF | 10.52 | 17.46 | 7.52 |
| d5 | 0.90 | 22.26 | 39.08 |
| d13 | 22.61 | 5.63 | 2.01 |
| d14 | 10.69 | 3.83 | 1.40 |
| d21 | 6.00 | 11.24 | 23.72 |
| d24 | 8.00 | 14.94 | 5.00 |

TABLE 12
ZOOM LENS UNIT DATA

| UNIT | STARTING SURFACE | FOCAL LENGTH |
|---|---|---|
| 1 | 1 | 57.16 |
| 2 | 6 | −9.38 |
| 3 | 15 | 21.15 |
| 4 | 22 | 28.56 |

### Numerical Example 4

TABLE 13

| i | ri | di | ni | [ni] i |
|---|---|---|---|---|
| 1 | 107.907 | 1.90 | 1.80610 | 33.3 |
| 2 | 29.867 | 5.50 | 1.49700 | 81.5 |
| 3 | −318.034 | 0.20 | 1. | |
| 4 | 33.475 | 3.20 | 1.77250 | 49.6 |
| 5 | 275.840 | VARIABLE | 1. | |
| 6 | 35.669 | 1.00 | 1.80610 | 40.7 |
| 7* | 8.123 | 4.79 | 1. | |
| 8 | −24.419 | 0.80 | 1.69680 | 55.5 |
| 9 | 15.204 | 0.70 | 1. | |
| 10 | 14.303 | 2.00 | 1.92286 | 18.9 |
| 11 | 47.173 | VARIABLE | 1. | |
| 12 | (STOP) | VARIABLE | 1. | |
| 13* | 9.520 | 2.70 | 1.58313 | 59.4 |
| 14 | −84.385 | 2.30 | 1. | |
| 15 | 16.410 | 0.70 | 1.84666 | 23.9 |
| 16 | 8.001 | 1.00 | 1. | |
| 17 | 18.086 | 1.60 | 1.49700 | 81.5 |
| 18 | 89.455 | VARIABLE | 1. | |
| 19 | 22.179 | 2.50 | 1.69680 | 55.5 |
| 20 | −24.645 | 0.60 | 1.84666 | 23.9 |
| 21 | −60.729 | VARIABLE | 1. | |
| 22 | INFINITY | 1.31 | 1.49831 | 65.1 |
| 23 | INFINITY | | | |

TABLE 14
ASPHERICAL SURFACE

| | | | | |
|---|---|---|---|---|
| (7TH SUFACE) | k = 1.77319E−1 | B = −2.03881E−5 | C = −5.82581E−7 | |
| (13TH SURFACE | k = −4.73317E−1 | B = 1.12159E−4 | C = 3.43802E−5 | D = 4.49684E−7 |
| | E = −1.35163E−9 | A′ = −1.51965E−4 | B′ = −1.01902E−4 | C′ = −6.03458E−6 |

TABLE 15
VARIOUS DATA

| ZOOM RATIO | 19.42 | | |
|---|---|---|---|
| | WIDE ANGLE | INTERMEDIATE | TELEPHOTO |
| FOCAL LENGTH | 5.15 | 22.72 | 99.99 |
| F NUMBER | 2.63 | 3.15 | 3.92 |
| ANGLE OF VIEW | 34.7 | 8.92 | 2.04 |
| IMAGE HEIGHT | 3.56 | 3.56 | 3.56 |
| OVERALL LENS | 84.55 | 88.76 | 97.61 |
| LENGTH | | | |
| BF | 10.72 | 18.09 | 7.47 |
| d5 | 0.80 | 22.72 | 36.73 |
| d11 | 25.18 | 6.40 | 2.00 |
| d12 | 9.20 | 4.81 | 2.00 |
| d18 | 7.16 | 5.61 | 17.91 |
| d21 | 6.00 | 13.37 | 2.76 |

TABLE 16
ZOOM LENS UNIT DATA

| UNIT | STARTING SURFACE | FOCAL LENGTH |
|---|---|---|
| 1 | 1 | 52.06 |
| 2 | 6 | −9.00 |
| 3 | 13 | 21.51 |
| 4 | 19 | 25.77 |

TABLE 17

| CONDITIONAL | FIRST | SECOND | THIRD | FOURTH |
|---|---|---|---|---|
| EXPRESSION | EMBODIMENT | EMBODIMENT | EMBODIMENT | EMBODIMENT |
| (1) | 4.28 | 3.59 | 4.23 | 41.48 |
| (2) | 1.17 | 1.05 | 0.97 | 4.54 |
| (3) | −0.36 | −0.36 | −0.36 | −0.01 |
| (4) | 1.98 | 1.99 | 1.80 | 1.40 |

An embodiment of a digital still camera, in which a zoom lens, such as that according to any one of the aforementioned embodiments, is used as an image taking optical system, will be described with reference to FIG. 9.

In FIG. 9, reference numeral 20 denotes a camera body, and reference numeral 21 denotes an image taking optical system formed by any one of the zoom lenses described in the first to fourth embodiments.

Reference numeral 22 denotes a solid-state image pickup element (photoelectric conversion element), such as a CCD sensor or a CMOS sensor, that receives an object image formed by the image taking optical system 21. Reference numeral 23 denotes a memory that records information corresponding to the object image subjected to photoelectric conversion by the solid-state image pickup element 22.

Reference numeral 24 denotes a finder formed by, for example, a liquid crystal display panel, and used for observing the object image formed on the solid-state image pickup element 22.

By applying the zoom lens according to the present invention to the image pickup apparatus such as the digital still camera in this way, it is possible to realize an image pickup apparatus that is small and that has high optical performance.

While the present invention has been described with reference to exemplary embodiments, it is to be understood that the invention is not limited to the disclosed exemplary embodiments. Various modifications and changes can be made within the gist of the present invention.

This application claims the benefit of Japanese Patent Application No. 2009-001447, filed Jan. 7, 2009, which is hereby incorporated by reference herein in its entirety.

1. A zoom lens comprising:
a first lens unit having a positive refractive power;
a second lens unit having a negative refractive power;
an aperture stop;
a third lens unit having a positive refractive power; and
a fourth lens unit having a positive refractive power,
wherein the first lens unit, the second lens unit, the aperture stop, the third lens unit, and the fourth lens unit are disposed in that order from an object side to an image side,
wherein each lens unit and the aperture stop move during zooming,
wherein, in zooming from a wide angle end to a telephoto end, the first lens unit moves along a locus convex toward the image side, and is positioned closer to an object at the telephoto end than at the wide angle end,
wherein, in zooming from the wide angle end to the telephoto end, the aperture stop moves along a locus convex toward the object side, and
wherein the following condition is satisfied:
3.4<M1/Mp<50.0
where, in zooming from the wide angle end to the telephoto end, an amount of movement of the first lens unit is M1 and an amount of movement of the aperture stop is Mp.

2. The zoom lens according to claim 1, wherein the following condition is satisfied:
0.7<Mpm/Mp<7.0
where a focal length of an entire system at the wide angle end is fw, a focal length of the entire system at the telephoto end is ft, the focal length fm of the entire system at an intermediate zooming position is fm=[square root](fw·ft), and an amount of movement of the aperture stop from the wide angle end to the intermediate zooming position is Mpm.

3. (canceled)

4. The zoom lens according to claim 1, wherein, in zooming from the wide angle end to the telephoto end, the second lens unit moves monotonically toward the image side.

5. The zoom lens according to claim 1, wherein the following condition is satisfied:
−0.8<Mp/M2<0.0
where, in zooming from the wide angle end to the telephoto end, an amount of movement of the second lens unit is M2.

6. The zoom lens according to claim 1, wherein the aperture stop moves so as to be positioned closer to the object at the telephoto end than at the wide angle end.

7. The zoom lens according to claim 1, wherein the following condition is satisfied:
1.3<[delta]dp/fw<4.0
where, in zooming from the wide angle end to the telephoto end, an amount of change in distance along an optical axis between the aperture stop and the third lens unit L3 is [delta]dp, and the focal length of the entire system at the wide angle end is fw.

8. The zoom lens according to claim 1, wherein the second lens unit includes at least two negative lenses at locations closest to the object.

9. The zoom lens according to claim 1, wherein an image is formed at a solid-state image pickup element.

10. An image pickup apparatus comprising:
the zoom lens according to claim 1; and
a solid-state image pickup element that receives an image formed by the zoom lens.
